(19) United States
(12) Patent Application Publication
(10) Pub. No.: US 2024/0143135 A1
(43) Pub. Date: May 2, 2024

(54) CONTROL APPARATUS, METHOD OF CONTROLLING CONTROL APPARATUS, AND STORAGE MEDIUM

(71) Applicant: CANON KABUSHIKI KAISHA, Tokyo (JP)

(72) Inventor: TAKESHI SUZUKI, Tokyo (JP)

(21) Appl. No.: 18/490,461

(22) Filed: Oct. 19, 2023

(30) Foreign Application Priority Data
Oct. 26, 2022 (JP) 2022-171624

(51) Int. Cl. G06F 3/0482; G06F 9/451

(52) U.S. Cl. CPC G06F 3/0482; G06F 9/451

(57) ABSTRACT

A control apparatus includes: a display control unit that performs control to display at least any one of multiple menu screens including a first type menu screen on which multiple menu items are arranged and a second type menu screen on which multiple menu items are arranged; and a control unit that performs control such that, even in a case where a first menu item arranged on the first type menu screen is in an unavailable situation, the first menu item is not deleted from the first type menu screen, and based on that a second menu item arranged on the second type menu screen is in an unavailable situation, the second menu item is deleted from the second type menu screen.

### BACKGROUND

### Field

The present disclosure relates to a technique of controlling a display screen.

### Description of the Related Art

Japanese Patent Laid-Open No. 2020-52972 discloses a multi function peripheral that displays a shortcut list screen in the form of tabs. In a general mode in which a registered user does not log in, the above-described multi function peripheral displays a common tab, and in a personal mode in which the registered user logs in, the above-described multi function peripheral displays the common tab and a personal tab corresponding to the user logging in. Additionally, the personal tab is managed so as to be able to be opened by password authentication or authentication using a card.

### SUMMARY

In recent years, an improvement in the operability of a display screen has been demanded.

A control apparatus according to an aspect of the present disclosure includes at least one memory and at least one processor and/or at least one circuit which function as: a display control unit that performs control to display at least any one of multiple menu screens including a first type menu screen on which multiple menu items are arranged and a second type menu screen on which multiple menu items are arranged; and a control unit that performs control such that, even in a case where a first menu item arranged on the first type menu screen is in an unavailable situation, the first menu item is not deleted from the first type menu screen, and based on that a second menu item arranged on the second type menu screen is in an unavailable situation, the second menu item is deleted from the second type menu screen.

Further features of the present invention will become apparent from the following description of exemplary embodiments with reference to the attached drawings.

### BRIEF DESCRIPTION OF THE DRAWINGS

FIG. 1 is a block diagram of an MFP;

FIGS. 2A and 2B are diagrams illustrating a default home screen displayed on an operation display unit;

FIGS. 3A and 3B are diagrams illustrating a custom home screen displayed on the operation display unit;

FIG. 4 is a diagram illustrating a locked screen of a custom home that is displayed on the operation display unit;

FIG. 5 is a diagram illustrating the custom home screen after being unlocked that is displayed on the operation display unit;

FIG. 6 is a flowchart illustrating an unlocking sequence of the custom home screen;

FIG. 7 is a flowchart illustrating a locking sequence of the custom home screen by a tab operation;

FIG. 8 is a diagram describing a screen transition of a display screen;

FIG. 9 is a flowchart illustrating a custom home screen locking sequence in a case where a backlight is turned off;

FIG. 10 is a flowchart illustrating an operation in selecting a specific app;

FIG. 11 is a diagram illustrating an error screen in a case where a cloud cooperative app is unavailable; and

FIG. 12 is a flowchart illustrating an operation in a case of turning on a backlight.

### DESCRIPTION OF THE EMBODIMENTS

Embodiments of the present disclosure are described below with reference to the drawings. Note that, the following embodiments are not intended to limit the present disclosure, and additionally, not all the combinations of the characteristics described in the present embodiments are necessarily required for the means for solving the problems of the present disclosure. Note that, the same reference numerals are given to describe the same configurations.

### Embodiment 1

### <Block Diagram>

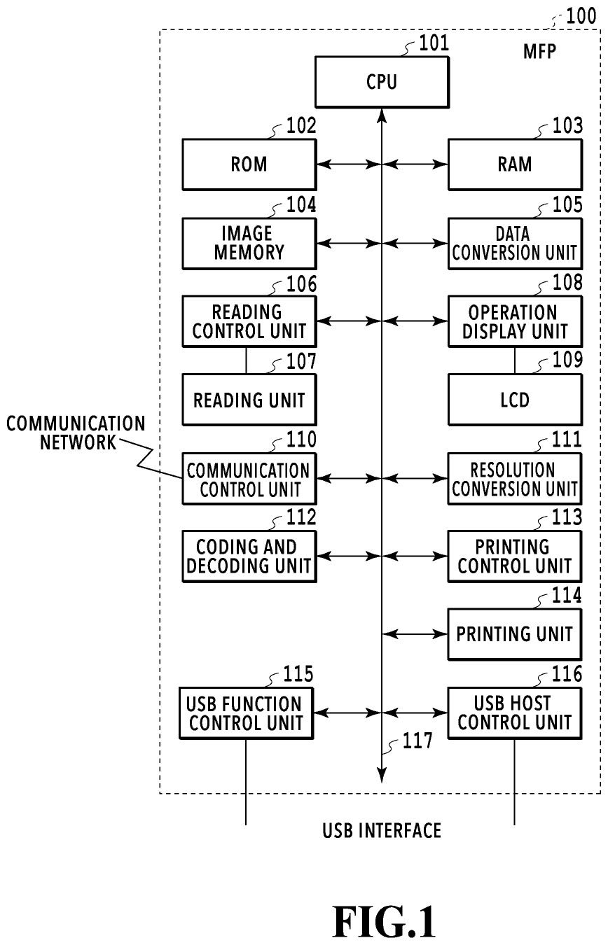

FIG. 1 is a block diagram illustrating a schematic configuration example of an MFP 100 in the present embodiment. The MFP 100 is a type of an information processing apparatus. Additionally, the MFP 100 is a type of an electronic apparatus. The MFP 100 of the present embodiment has an information processing function such as generating, storing, and transmitting device information including log information and status information. Additionally, the MFP 100 has an image formation function to form an image on a printing medium by using a printing control unit 113 and a printing unit 114 described later.

The MFP 100 includes a CPU 101, a ROM 102, a RAM 103, an image memory 104, a data conversion unit 105, a reading control unit 106, a reading unit 107, an operation display unit 108, an LCD 109, a communication control unit 110, and a resolution conversion unit 111. In addition, the MFP 100 includes a coding and decoding unit 112, the printing control unit 113, the printing unit 114, a USB function control unit 115, a USB host control unit 116, and a bus 117.

The CPU 101 is a system control unit and controls overall the MFP 100. The ROM 102 is a non-volatile memory that stores fixed data such as a control program to be executed by the CPU 101, a data table, and an embedded operating system (OS). In the present embodiment, each control program is stored in the ROM 102, and software execution control such as scheduling, task switching, or interruption processing is performed under the management by the embedded OS stored in the ROM 102. The ROM 102 stores information indicating a permission state, which indicates whether to provide device information to the outside. The RAM 103 is formed of a static random access memory (SRAM) or the like that requires a backup power supply, and feeding to the RAM 103 is guaranteed by a not-illustrated primary battery for data backup. The RAM 103 stores a program control variable and the like. The image memory 104 is formed of a dynamic random access memory (DRAM) or the like and can accumulate image data. Additionally, a part of the area in the image memory 104 is secured as a work area to execute software processing. The data conversion unit 105 can perform conversion of the image data such as page description language (PDL) analysis and computer graphics (CG) rasterization of character data.

The reading unit 107 optically reads an original document by a CIS image sensor and converts it into an electric image signal. The reading control unit 106 performs various types of image processing such as binarization processing and halftone processing to this image signal and outputs high-definition image data. Note that, a method of optically reading the original document may be either of: a sheet reading control method in which the original document is read by a fixed CIS image sensor; and a book reading control method in which the original document fixed on a platen glass is read by a moving CIS image sensor.

The operation display unit 108 includes a minimal key such as a numerical value input key, a mode setting key, a determination key, and a cancel key and a light-emitting diode (LED), a seven-segment display unit, or the like. The above-described various keys are implemented by so-called software keys display-controlled on the LCD 109 and can receive an operation from the user. In a case where an operation by the user is not performed for a certain period of time, the LCD 109 switches off a backlight of the LCD 109 to reduce the power consumption.

The communication control unit 110 controls communication between the MFP 100 and a communication network 300 and establishes connection to an Internet service provider and communication of various data with a service management server 200. Additionally, the communication control unit 110 can determine whether the MFP 100 is connected to the Internet or is connected to only a LAN. Note that, the connection between the communication control unit 110 and the communication network 300 is established by a publicly known method such as HTTP and XMPP. The resolution conversion unit 111 performs resolution conversion processing such as mutual conversion between image data in millimeters and image data in inches. Note that, the resolution conversion unit 111 also can execute enlarging and reducing processing on the image data.

The coding and decoding unit 112 performs coding and decoding processing or performs enlarging and reducing processing on the image data (uncompressed, MH, MR, MMR, JBIG, JPEG, and so on) handled by the MFP 100. The printing control unit 113 performs various types of image processing such as smoothing processing, printing density correction processing, and color correction on the image data to be printed to convert it into high-definition image data and then outputs it to the printing unit 114. Additionally, the printing control unit 113 also plays a role to regularly obtain state information data of the printing unit 114. The printing unit 114 is formed of a laser beam printer, an ink-jet printer, or the like and prints the image data generated by the printing control unit 113 on the printing medium such as a sheet.

The USB function control unit 115 performs protocol control according to the USB communication standard. The USB host control unit 116 is a control unit to establish communication based on the protocol determined by the USB communication standard. This USB communication standard is a standard for bidirectional high-speed data communication. This USB communication standard defines that multiple hubs or functions (slaves) are connectable to a single host (master). That is, the USB host control unit 116 provides a function as a host in the USB communication. The constituents other than the reading unit 107 and the LCD 109 are connected to each other through the bus 117.

### <Operation Display Unit>

The operation display unit 108 according to the present embodiment includes a screen in the form of tabs.

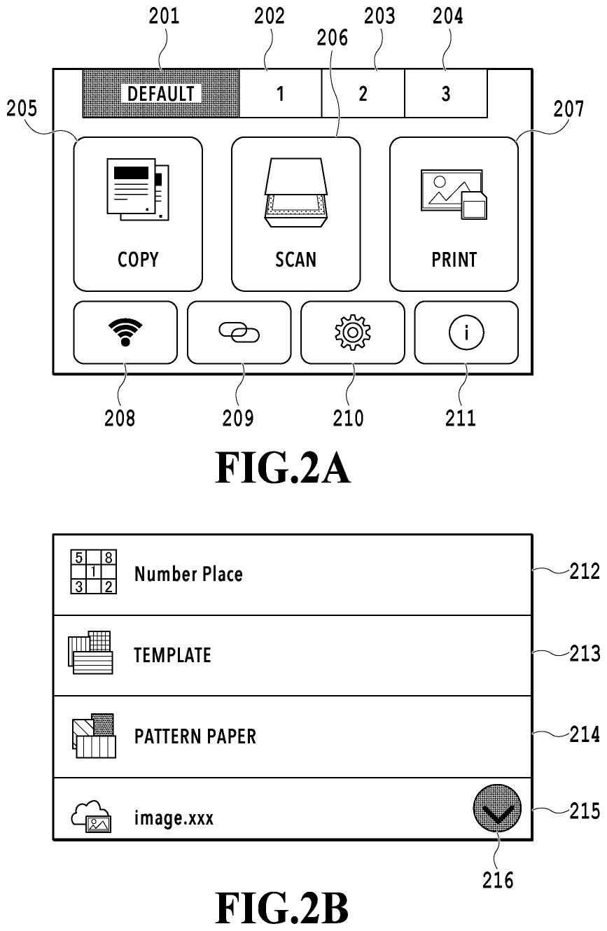

FIGS. 2A and 2B are diagrams related to a default tab displayed on the operation display unit 108. FIG. 2A is a diagram illustrating a default home screen displayed on the operation display unit 108. A tab 201 is a tab corresponding to the default home screen. Tabs 202, 203, and 204 are tabs each corresponding to a custom home screen. The user can switch a home screen by pressing the tab. Additionally, the different tab color of the tab 201 from the color of the other tabs indicates that the screen of the tab 201 (that is, the default home screen) is currently displayed. The default home screen includes a copy menu button 205, a scan menu button 206, a print menu button 207, a LAN button 208, a wireless connection button 209, a setting button 210, and a hint button 211. A transition to a screen corresponding to each button is made with the user pressing each button. Specifically, for example, in a case where the copy menu button 205 is pressed, an area into which the setting for copying is inputted or a screen to instruct the execution of copying is displayed. On the default home screen, unlike the custom home screen described later, a button that is determined in advance is displayed without the arbitrary selection by the user. However, it is not limited to this mode, and a mode in which the user can arbitrarily select or change the button to be displayed on the default home screen may be applicable.

FIG. 2B is a diagram illustrating a default print menu screen displayed on the operation display unit 108. A transition to this screen is made with the user pressing the print menu button 207. The default print menu screen displays function options in the form of a list. For example, in FIG. 2B, multiple function options such as Number Place 212, template 213, pattern paper 214, and image.xxx 215 can be arranged. A transition to a screen of a print app corresponding to each function option is made with the user pressing the function option. Specifically, for example, in a case where the template 213 is pressed, an area to select a type of a format to be printed (for example, a notebook, a staff notation, and so on) or a sheet size (A4, B5, and so on) or a screen to instruct the execution of printing is displayed.

Additionally, although only four function options are displayed in FIG. 2B, it is possible to display other function options hiding in a lower portion by pressing a transition button 216 to scroll down. Specifically, for example, in a case where five print apps are registered on this list, the template 213, the pattern paper 214, the image.xxx 215, and a not-illustrated fifth print app are displayed by pressing the transition button 216 to scroll down.

Moreover, the print app that can be arranged in the print menu includes a cloud cooperative app. The cloud cooperative app is an app that allows the MFP 100 and the service management server 200 to cooperate and provide a function such as printing. The cloud cooperative app can be added or deleted by an operation by the user. For example, the Number Place 212 illustrated in FIG. 2B is the cloud cooperative app. With an instruction to execute printing through the Number Place 212, printing of a problem of Number Place, which is different every time, is executed from the service management server 200 to the MFP 100.

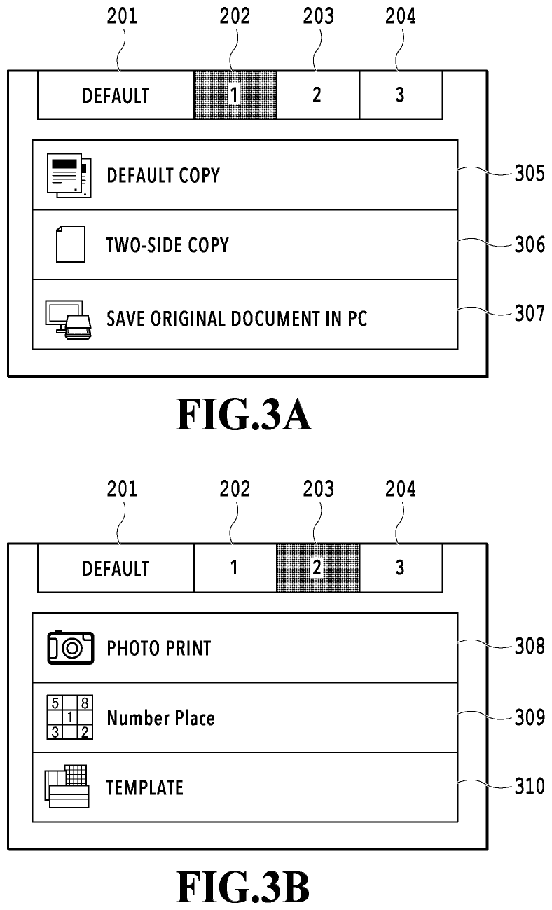

FIGS. 3A and 3B are diagrams illustrating the custom home screen displayed on the operation display unit. The custom home screen is a home screen on which the user can arrange an arbitrary function option. Note that, in the present embodiment, the number of the function options arranged on the custom home screen is three, and the same applies to all the three tabs (the tab 202, the tab 203, and the tab 204) for displaying the custom home screen, which are displayed in FIG. 3A.

FIG. 3A is a diagram illustrating the custom home screen of the tab 202 displayed on the operation display unit 108. The different tab color of the tab 202 from the color of the other tabs indicates that the custom home screen of the tab 202 is currently displayed. On the custom home screen of the tab 202, the function option is arranged as with the default print menu illustrated in FIG. 2B. The function option is also referred to as a custom menu. In FIG. 3A, custom menus 305, 306, and 307 are arranged, and each menu is a menu that can be customized by the user. Moreover, it is possible to designate a function to be displayed in each menu position. In FIG. 3, “default copy” is set as the custom menu 305, “two-side copy” is set as the custom menu 306, and “save original document in pc” is set as the custom menu 307, respectively. Note that, unlike the default home screen, it is possible to register a menu associated with setting of processing executed from each menu on the custom home screen. That is, for example, in a case of the copying executed from the copy menu button 205, it is necessary to set additionally whether the copying is two-side copy or one-side copy after the copy menu button 205 is pressed. However, in a case of the copying executed from the custom menu 306, it is unnecessary to set additionally whether the copying is two-side copy or one-side copy after the custom menu 306 is pressed. Additionally, login information and cookie information may be saved in association with each home screen. Moreover, it is possible to set a lock to each custom home screen. In the present embodiment, the lock means control to prevent displaying of the custom home screen in a case where there is no input of a correct password into a password input screen. In a case of the custom home screen to which no lock is set, once the tab corresponding to the custom home screen is operated, the custom home screen is displayed without displaying the password input screen. The setting of the custom menu and the setting of the lock of the custom home screen can be performed from the setting button 210 in FIG. 2.

FIG. 3B is a diagram illustrating the custom home screen of the tab 203 displayed on the operation display unit 108. The custom home screen of the tab 203 includes custom menus 308, 309, and 310. Additionally, each menu is a menu that can be customized by the user, and it is possible to designate the function to be displayed in each menu position. In FIG. 3B, “photo print” is set as the custom menu 308, “Number Place” is set as the custom menu 309, and “template” is set as the custom menu 310, respectively.

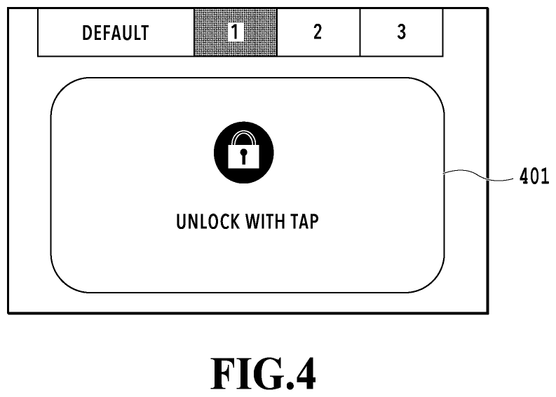

FIG. 4 is a diagram illustrating a locked screen of the tab 202 that is displayed on the operation display unit 108. In a case where the user selects the tab 202, which is a tab corresponding to the locked custom home screen, the custom home screen is not displayed but the screen illustrated in FIG. 4 is displayed. With the user pressing an unlock button 401, the password input screen is displayed, and if the inputted password matches the correct password, the custom home screen of the tab 202 is displayed. Note that, the correct password is set for each tab. Note that, in the present embodiment, although the custom home screen is displayed by the unlocking using password authentication, another authentication method may be applicable. For example, the custom home screen may be displayed by the unlocking using biometric authentication. Additionally, in the present embodiment, a locked state is a state in which a user operation on the menu screen corresponding to the selected tab is limited. For example, it is a state in which the menu screen corresponding to the selected tab is not displayed as illustrated in FIG. 4. Alternatively, it may be a state in which the menu screen corresponding to the selected tab is displayed but the user cannot change the contents displayed on the menu screen.

In the present embodiment, in a case where a menu of another tab is displayed from the custom home screen of the tab 202 currently displayed, and thereafter the tab 202 is pressed again, the locked screen is not displayed, and the custom home screen of the tab 202 is displayed without the password input by the user.

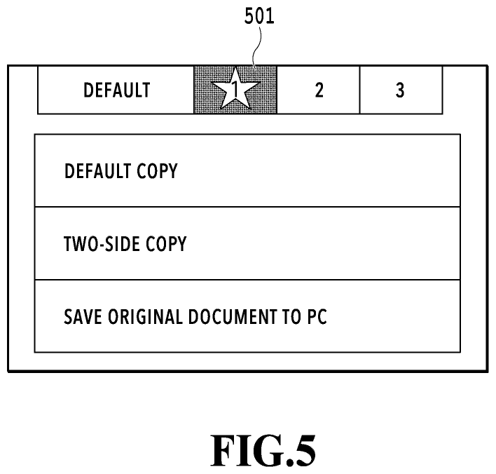

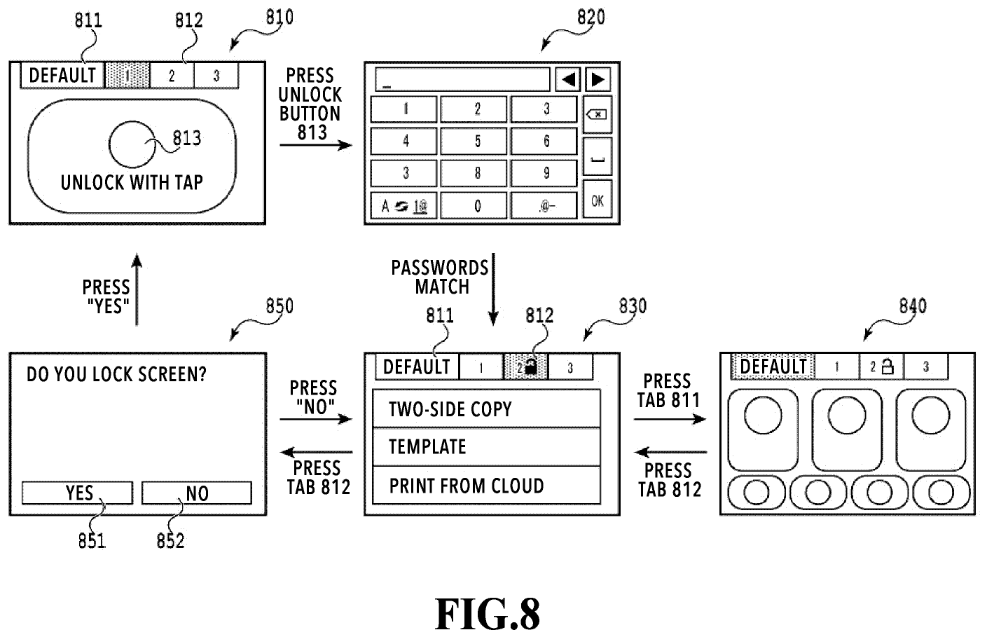

FIG. 5 is the unlocked custom home screen displayed on the operation display unit 108. An unlocked state icon 501 indicates that the lock setting of the currently displayed custom home screen corresponding to the tab 202 is unlocked. Note that, an icon that indicates that the lock setting is unlocked is not limited to 501 in FIG. 5. For example, an icon that indicates that it is unlocked like 812 in FIG. 8 may be applicable.

In the present embodiment, the user can lock the tab by pressing the unlocked state icon (that is, the tab 202 in FIG. 5). Note that, the unlocked state icon 501 is not displayed on a tab in which the lock setting is ineffective, and no processing is performed even in a case where the tab of the custom home screen currently displayed is pressed. Note that, the setting of whether to make the lock setting of the tab effective or ineffective is performed in advance for each tab. The setting of whether to make the lock setting of the tab effective or ineffective may be performed from the setting button 210, for example.

### <Flowchart>

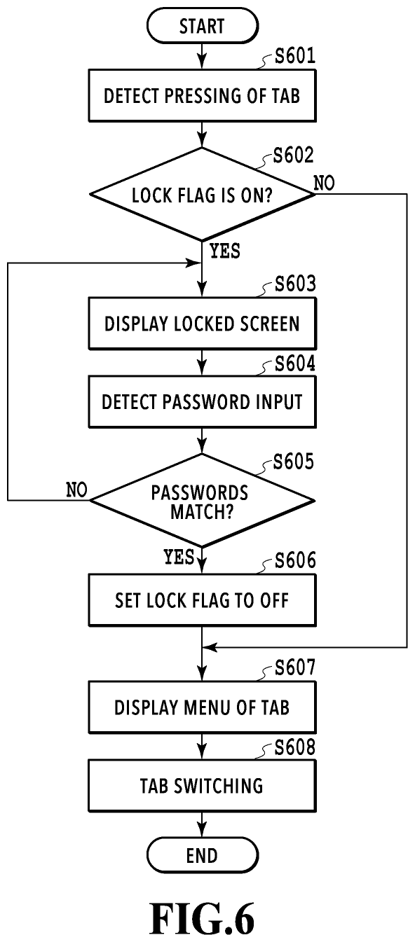

FIG. 6 is a flowchart describing an unlocking sequence of the present embodiment. A flow of the processing by the user to unlock the tab is described with reference to FIG. 6. A series of the processing illustrated in the present flowchart is performed with the CPU 101 of the MFP 100 deploying a program code stored in the ROM 102 to the RAM 103 to execute. Note that, “S” in each description of the processing below means that it is a step in the flowchart, and the same applies to the subsequent embodiments. The present processing is executed in a case where the user presses the tab of the custom home screen. Additionally, the present processing is started with the operation display unit 108 detecting an operation by the user such as touching.

First, in S601, the CPU 101 detects the tab that is pressed by the user. In S602, the CPU 101 determines whether a lock flag of the tab is ON. The lock flag of the tab is individually prepared for each tab and is set to ON in a locking operation of the tab. Details related to the locking operation of the tab are described later. If the lock flag is OFF, in S607, the CPU 101 displays the menu of the tab. Note that, the lock flag of the tab in which the lock setting is ineffective is constantly OFF. As mentioned above, the setting of whether to make the lock setting of the tab effective or ineffective is set in advance for each tab.

If the lock flag is ON, in S603, the CPU 101 displays the locked screen as illustrated in FIG. 4. In S604, once the CPU 101 detects the password input from the user, in S605, whether the passwords match is determined. If the passwords do not match, the locked screen is displayed again in S603. If the passwords match, in S606, the lock flag is set to OFF, and thereafter, in S607, the menu of the tab is displayed.

In S608, in a case where the switching to another tab is performed by the user operation, the CPU 101 maintains the state of the lock flag of the previous tab before the switching, in which the lock flag is set to OFF in S606, to OFF. Thus, in a case where it is detected in S601 that the tab is pressed again, it is determined in S602 that the lock flag is OFF, and the user can display the menu of the tab without inputting the password. This is the flow of the processing to unlock the tab.

Next, processing by the user to lock the tab is described.

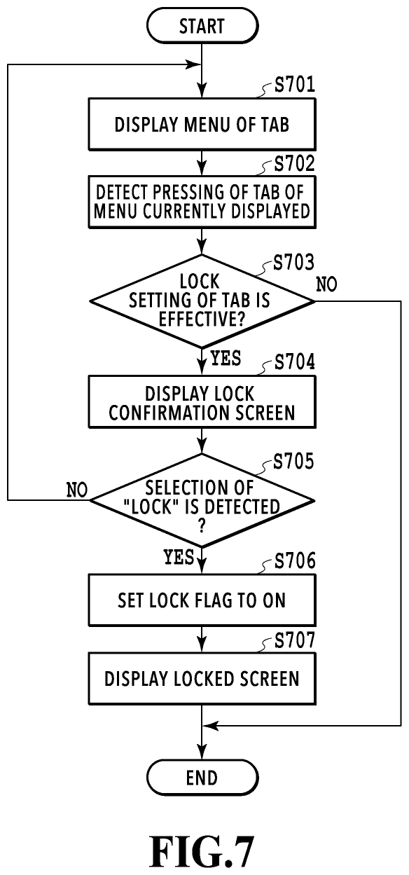

FIG. 7 is a flowchart describing a processing sequence in a case where the user locks the tab. A series of the processing illustrated in the present flowchart is performed with the CPU 101 of the MFP 100 deploying a program code stored in the ROM 102 to the RAM 103 to execute. The present processing is started with the tab being set to the unlocked state by an unlocking operation by the user such as password authentication.

In S701, the CPU 101 displays the menu of the tab on the operation display unit 108. In S702, the CPU 101 determines whether the pressing of the tab of the menu currently displayed on the operation display unit 108 is detected. In the present step, for example, if it is determined that no pressing of the tab is detected until a period of time determined in advance passes, the CPU 101 ends the present processing. On the other hand, if it is determined that the pressing of the tab is detected until the period of time determined in advance passes, in S703, whether the lock setting of the tab is effective is determined. As mentioned above, the setting of whether to make the lock setting of the tab effective or ineffective is performed in advance for each tab. If the lock setting of the tab is ineffective, the processing ends. If the lock setting of the tab is effective, in S704, a lock confirmation screen is displayed. The lock confirmation screen is a display screen 850 in FIG. 8, for example. Meanwhile, the user selects whether to lock the tab on the lock confirmation screen. If it is detected that do not lock is selected by the user operation on the lock confirmation screen, the CPU 101 causes the processing to return to S701. If it is detected in S705 that to lock is selected, in S706, the CPU 101 sets the lock flag to ON, and after the locked screen is displayed in S707, the processing ends. This is the flow of the processing in a case where the tab is locked by the user.

Next, a series of flows of locking and unlocking the tab in FIGS. 6 and 7 described above is described by using the screen displayed on the operation display unit 108.

FIG. 8 is a diagram describing a transition of a display screen in a case where the tab is locked and unlocked. First, a display screen 810 is a display screen in a case where the user presses a tab 812 in which the lock flag is ON. This is a display screen corresponding to S601 to S603 in the flowchart in FIG. 6. In a case where the user presses an unlock button 813 on the display screen 810, a display screen 820 that is a password input screen is displayed. In a case where the user inputs the correct password, a display screen 830 is displayed. This display screen 830 is a display screen corresponding to the tab 812 and is a screen corresponding to S607 in FIG. 6. Additionally, on the display screen 830, a mark indicating that it is the unlocked state is displayed on the tab 812.

In a case where the user presses a tab 811, which is a default tab, on the display screen 830 of this tab 812, a default home screen 840 is displayed. In this process, the tab 812 in the unlocked state maintains the unlocked state with no change. In a case where the operation on the default home screen 840 ends, and the user presses the tab 812 again, the display screen 830 is displayed without performing the unlocking operation. In this case, in a case where the user presses the tab 812 on which the mark indicating that it is the unlocked state is displayed, the display screen 850 is displayed. That is, in the present embodiment, the tab becomes a re-lock button while the menu of the tab is displayed. Note that, the above descriptions (that is, a screen transition from the display screen 830 to the display screen 850) are a screen transition corresponding to S702 to S704 in FIG. 7. The display screen 850 is a display screen to select whether to lock the screen, and in a case where the user presses a yes button 851, the concerned tab 812 is switched into the locked state. In a case where a no button 852 is pressed, the display screen 830 is displayed. This is a description of a case where the tab is locked and unlocked by using the display screen displayed on the operation display unit 108.

Next, a method of setting all the tabs in which the lock setting is effective to the locked state in a case where the backlight of the operation display unit 108 is off is described. The backlight of the operation display unit 108 is turned on in a case where the user operates the operation display unit 108 and is turned off to reduce the power consumption in a case where the operation by the user is not detected for a certain period of time in the on state.

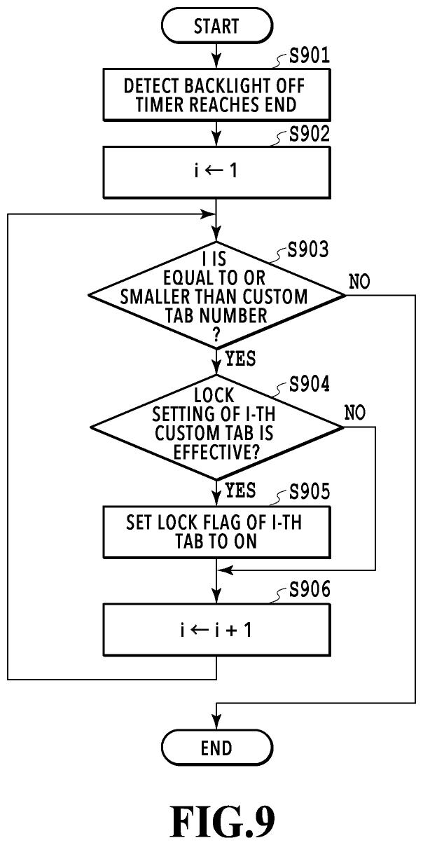

FIG. 9 is a flowchart describing a locking processing sequence in a case where the backlight is off. A series of the processing illustrated in the present flowchart is performed with the CPU 101 of the MFP 100 deploying a program code stored in the ROM 102 to the RAM 103 to execute.

In S901, once the CPU 101 detects that a backlight off timer reaches the end, in S902, the CPU 101 initializes an index i to 1. In S903, the CPU 101 determines whether the index i is equal to or smaller than the custom tab number. If the index i is equal to or smaller than the custom tab number in S903, in S904, the CPU 101 determines whether the lock setting of the i-th custom tab is effective. If the lock setting of the i-th custom tab is effective, in S905, the CPU 101 sets the lock flag of the i-th custom tab to ON.

If the lock setting of the i-th custom tab is ineffective in S904, or after the lock flag of the i-th custom tab is set to ON in S905, in S906, the CPU 101 increments the index i by one. After S906 is executed, in S903, whether the index i is equal to or smaller than the custom tab number is determined again. If the index i is greater than the tab number in S903, the CPU 101 ends the present processing. Thus, it is possible to lock the tabs in the ascending order of the number of the tabs until the index i reaches the same value as the custom tab number. That is, it is possible to set all the tabs with the effective lock setting to the locked state at the timing at which the backlight is turned off. With this processing, even in a case where the user after finishing with the operation forgets an operation such as logging out, it is possible to lock the tab that should be in the locked state after a certain period of time passes.

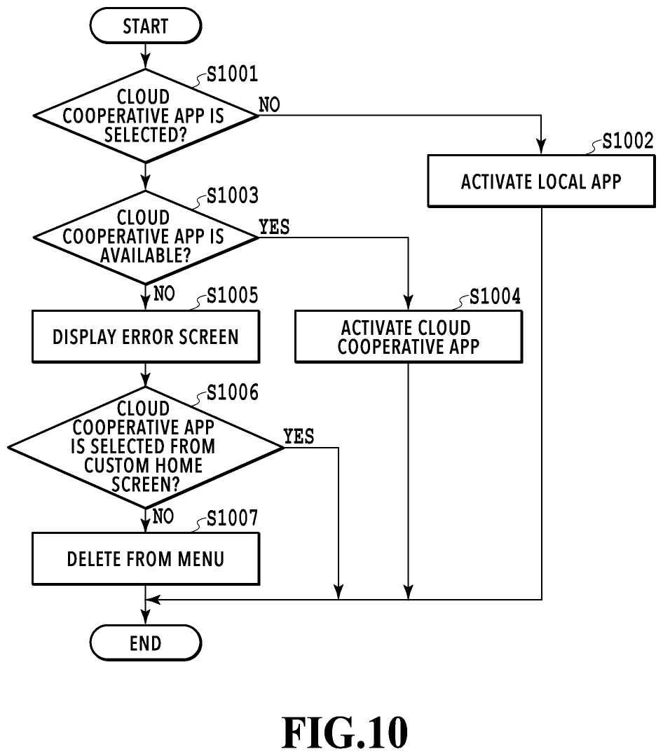

FIG. 10 is a flowchart illustrating an operation in selecting a specific app. The cloud cooperative app arranged on the default print menu screen or the custom home screen of the MFP 100 may be unavailable in some cases because the app is deleted by the user in a cooperating terminal or the termination or shutdown of the application service. In this case, even if the cloud cooperative app is selected by the MFP 100 side, the app is unavailable. The screen displaying or the processing on the MFP 100 side in such a case is described. A series of the processing illustrated in the present flowchart is performed with the CPU 101 of the MFP 100 deploying a program code stored in the ROM 102 to the RAM 103 to execute. Additionally, the present processing is started in a case where any one of the apps arranged on the menu screen is selected by the user.

First, in S1001, the CPU 101 determines whether the app selected by the user is the cloud cooperative app. If it is determined that the cloud cooperative app is selected, the processing proceeds to S1003. On the other hand, if it is determined that the cloud cooperative app is not selected, the processing proceeds to S1002. For example, in a case where the user selects the default copy 305, since this app does not use a cloud function (that is, this app is not the cloud cooperative app), in S1002, the CPU 101 activates a default copy app as a local app. Thereafter, the present processing ends.

On the other hand, for example, if the user selects the Number Place 212 illustrated in FIG. 2B, since the Number Place 212 is the cloud cooperative app that uses the cloud function, the processing transitions to S1003.

In S1003, the CPU 101 determines whether the cloud cooperative app is available. In the determination processing in the present step, for example, the MFP 100 may inquire of the service management server 200 whether the cloud cooperative app selected by the user is available and may make determination in accordance with a response from the service management server 200. If a response that the app is available is received from the server side, the processing transitions to S1004. On the other hand, for example, in a case where the service of the cloud cooperative app selected by the user is already terminated, and if a response that the service is terminated is received from the service management server 200, the processing transitions to S1005.

In S1004, the CPU 101 activates the Number Place 212 app as the cloud cooperative app. Thereafter, the present processing ends.

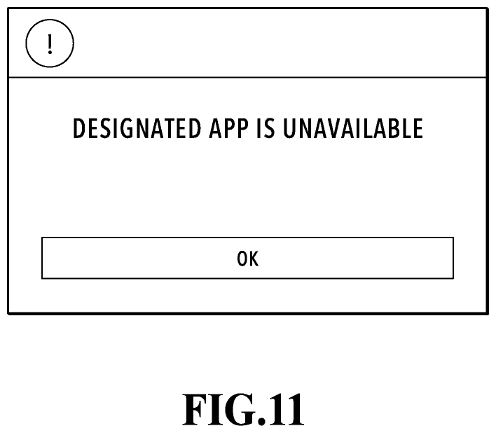

In S1005, in order to notify the user of that the cloud cooperative app selected by the user is unavailable, the CPU 101 performs the error displaying on the operation display unit 108. An error screen is described later with reference to FIG. 11.

Subsequently, in and after S1006, processing to delete the cloud cooperative app that is determined as unavailable from the display of the menu screen is performed. In S1006, the CPU 101 determines whether the user activates the app from the custom home screen. For example, a case where the user selects the Number Place 309 arranged on the custom home screen of the tab 203 illustrated in FIG. 3B is assumed. In this case, since the number of the print apps arranged on the custom home screen becomes less than a predetermined number (in the present embodiment, three) once the app is deleted from the custom home screen, there is a possibility that the custom home screen cannot be displayed in a normal manner. For this reason, the processing ends without the deleting.

On the other hand, for example, if the user selects the Number Place 212 on the default print menu screen illustrated in FIG. 2B, the processing transitions to S1007, and the CPU 101 deletes the Number Place 212 from the default print menu screen.

On the default home screen, the print app that is arranged as default is also arranged in addition to the cloud cooperative app. For this reason, even in a case where the cloud cooperative app is deleted, the display of the menu screen never loses the shape. For example, in a case where the Number Place 212 illustrated in FIG. 2B is deleted, the default print menu screen after the deleting displays the template 213 at the top. Therefore, in a case where the cloud app is selected from the default home screen, and the app is in an unavailable situation, an error indicating that the app is unavailable is displayed on the screen, and the app is deleted.

Note that, a mode in which the unavailable app on the default home screen is deleted in a case where a predetermined operation is performed on the error screen displayed in S1005 may be applicable, or a mode in which the deleting is performed without a predetermined operation by the user before the error is displayed on the screen may be applicable.

Additionally, although it is determined in S1003 whether the app selected in S1001 is available, it is not limited to this mode, and for example, a mode in which the arranged app is displayed in such a way that it is obvious that the app is available at a stage of opening the print menu screen may be applicable.

FIG. 11 is a diagram illustrating the error screen in a case where the cloud cooperative app is unavailable. In a case where the cloud cooperative app selected by the user is unavailable, the error indicating that the app is unavailable is displayed on the operation display unit 108. Additionally, the user can return to the previous screen before selecting the app by pressing an OK button.

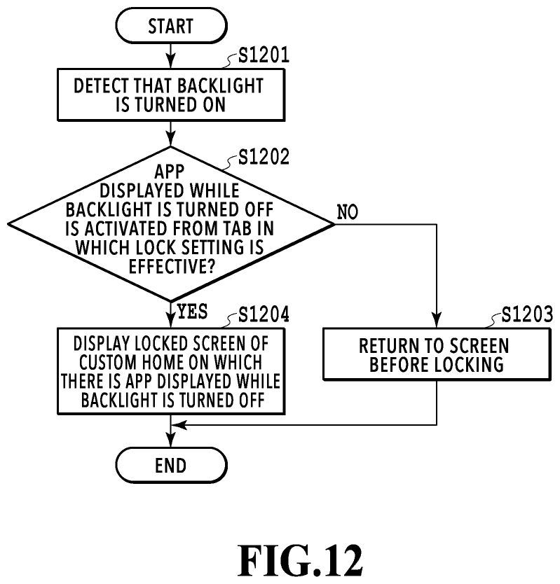

FIG. 12 is a flowchart illustrating an operation in a case of turning on the backlight of the operation display unit 108. A series of the processing illustrated in the present flowchart is performed with the CPU 101 of the MFP 100 deploying a program code stored in the ROM 102 to the RAM 103 to execute. The present processing is started with the user operating the operation display unit 108 or the MFP 100 communicating with a not-illustrated external PC or external terminal such as a smartphone.

In S1201, the CPU 101 detects that the backlight is turned on. In S1202, the CPU 101 determines whether the app that is displayed while the backlight is turned off is activated from the tab in which the lock setting is effective. If the app is activated from the tab in which the lock setting is ineffective, the processing transitions to S1203, and if the app is activated from the tab in which the lock setting is effective, the processing transitions to S1204.

In S1203, the CPU 101 displays the screen that is displayed before the locking. For example, a case where the Number Place app, which is the cloud cooperative app from the Number Place 309 arranged on the custom home screen of the tab 203 in which the lock setting is ineffective, is activated is assumed. In this case, a screen of the Number Place 309 app is displayed without displaying the locked screen. Thereafter, the present processing ends.

On the other hand, in a case where the app is activated from the tab in which the lock setting is effective, in S1204, the CPU 101 displays the locked screen of the custom home screen on which there is the app that is displayed while the backlight is turned off. For example, a case where the tab 203 illustrated in FIG. 3B is the tab in which the lock setting is effective is assumed. Even if the screen that is displayed last time is an in-execution screen of the Number Place 309 arranged on the tab 203, since the lock setting of the tab 203 is effective, the locked screen of the tab 203 is displayed in turning on the backlight. Then, the custom home screen of the tab 203 is displayed with the user inputting the correct password of the tab 203. Thereafter, the present processing ends.

As described above, according to the present embodiment, it is possible to improve the operability of the display screen. Specifically, in a case where the app is unavailable, if the screen is in the form of a list like the print menu of the default home screen, the app is deleted, and if the screen constantly displays the fixed number of apps like the custom home, the app is not deleted. Therefore, for the user using the custom home, the fixed number of apps are constantly displayed, and the operability is uniformed and thus improved.

Note that, although the display screen of the MFP 100 is described as an example in the present embodiment, it is not limited thereto, and the present embodiment may be applicable to any apparatus as long as the apparatus includes an operation display unit. Additionally, for example, the MFP 100 may cause another apparatus (a smartphone or a PC) communicated with the MFP 100 to display each screen described above to execute the setting of the MFP 100 and to cause the MFP 100 to execute various types of processing. Moreover, the present disclosure may be applicable to the screen displayed on the other apparatus.

### OTHER EMBODIMENTS

The present disclosure can also be implemented by processing in which a program that implements one or more functions of the above-described embodiment is supplied to a system or an apparatus through a network or a storage medium, and one or more processors in a computer of the system or the apparatus read and execute the program. Additionally, the present disclosure can also be implemented by a circuit (for example, an ASIC) that implements one or more functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-171624, filed Oct. 26, 2022, which is hereby incorporated by reference wherein in its entirety.

What is claimed is:

1. A control apparatus comprising at least one memory and at least one processor and/or at least one circuit which function as:
a display control unit that performs control to display at least any one of a plurality of menu screens including a first type menu screen on which a plurality of menu items are arranged and a second type menu screen on which a plurality of menu items are arranged; and
a control unit that performs control such that, even in a case where a first menu item arranged on the first type menu screen is in an unavailable situation, the first menu item is not deleted from the first type menu screen, and based on that a second menu item arranged on the second type menu screen is in an unavailable situation, the second menu item is deleted from the second type menu screen.

2. The control apparatus according to claim 1, wherein
the control unit performs control such that
error displaying to indicate that the first menu item is unavailable is performed based on that the first menu item arranged on the first type menu screen is in the unavailable situation, and
error displaying to indicate that the second menu item is unavailable is performed based on that the second menu item arranged on the second type menu screen is in the unavailable situation, and the second menu item is deleted from the second type menu screen.

3. The control apparatus according to claim 2, wherein
the control unit performs control such that
error displaying to indicate that the first menu item is unavailable is performed in accordance with that the first menu item is selected by a user while the first menu item arranged on the first type menu screen is in the unavailable situation, and
error displaying to indicate that the second menu item is unavailable is performed in accordance with that the second menu item is selected by the user while the second menu item arranged on the second type menu screen is in the unavailable situation, and the second menu item is deleted from the second type menu screen.

4. The control apparatus according to claim 1, wherein
the first type menu screen is a screen on which a predetermined number of menu items are arranged, and
the second type menu screen is a screen on which a greater number of menu items than the predetermined number can be arranged.

5. The control apparatus according to claim 4, wherein
the second type menu screen is a screen on which a specific display item to receive an instruction to switch a plurality of menu items displayed out of all the menu items included in the second type is displayed, and the specific display item is not displayed on the first type menu screen.

6. The control apparatus according to claim 1, wherein
the first type menu screen is a screen on which a plurality of menu items selected by a user are arranged, and
the second type menu screen is a screen on which a plurality of menu items determined in advance not based on the selection by the user are arranged.

7. The control apparatus according to claim 1, wherein
the first menu item and the second menu item are menu items to execute the same specific function.

8. The control apparatus according to claim 7, wherein
the specific function is a function to execute printing in cooperation with a cloud.

9. The control apparatus according to claim 8, wherein
the specific function is a function to print a problem of Number Place.

10. The control apparatus according to claim 1, wherein
the display control unit performs control to display a plurality of display elements corresponding to the plurality of menu screens, respectively, and in accordance with that any one of the plurality of display elements is selected by the user, the display control unit performs control to display a menu screen corresponding to the selected display element.

11. The control apparatus according to claim 10, wherein
the plurality of display elements are a plurality of tabs.

12. The control apparatus according to claim 1 further comprising the at least one memory and at least one processor and/or at least one circuit further function as a locking unit that controls at least one of the plurality of menu screens corresponding to a plurality of tabs to a locked state, wherein
based on lock setting individually set in each tab in advance, the locking unit performs control to set the locked state, and based on that a backlight of the display unit is turned off, the locking unit performs control to set all the menu screens of the tabs that are displayed on the display screen and in which the lock setting is effective to the locked state,
in a case where a screen displayed in a case where the backlight of the display unit is turned off is displayed because the menu item arranged on the menu screen corresponding to the tab in which the lock setting is effective is selected, a locked screen of the menu screen corresponding to the tab in which the lock setting is effective is displayed in a case where the backlight is turned on, and
in a case where a screen displayed in a case where the backlight of the display unit is turned off is displayed because the menu item arranged on the menu screen corresponding to the tab in which the lock setting is ineffective is selected, the screen that is displayed while the backlight of the display unit is turned off is displayed without displaying the locked screen in a case where the backlight is turned on.

13. The control apparatus according to claim 1, wherein
both the first menu item and the second menu item are items corresponding to a function to operate in cooperation with a server.

14. The control apparatus according to claim 13, wherein
a situation in which the first menu item is unavailable and a situation in which the second menu item is unavailable are both a state in which a corresponding service is shut down on a server side.

15. The control apparatus according to claim 13, wherein
the situation in which the first menu item is unavailable and the situation in which the second menu item is unavailable are both a state in which usage of a corresponding service is stopped by a user.

16. The control apparatus according to claim 1, further comprising:
a printer that prints an image on a sheet.

17. A non-transitory computer readable storage medium storing a program which functions in a control apparatus and causes the control apparatus to function as:
a display control unit that performs control to display at least any one of a plurality of menu screens including a first type menu screen on which a plurality of menu items are arranged and a second type menu screen on which a plurality of menu items are arranged; and
a control unit that performs control such that, even in a case where a first menu item arranged on the first type menu screen is in an unavailable situation, the first menu item is not deleted from the first type menu screen, and based on that a second menu item arranged on the second type menu screen is in an unavailable situation, the second menu item is deleted from the second type menu screen.

18. A method of controlling a control apparatus comprising:
performing control to display at least any one of a plurality of menu screens including a first type menu screen on which a plurality of menu items are arranged and a second type menu screen on which a plurality of menu items are arranged; and
performing control such that, even in a case where a first menu item arranged on the first type menu screen is in an unavailable situation, the first menu item is not deleted from the first type menu screen, and based on that a second menu item arranged on the second type menu screen is in an unavailable situation, the second menu item is deleted from the second type menu screen.
